(19) United States
(12) Patent Application Publication
(10) Pub. No.: US 2021/0186296 A1
(43) Pub. Date: Jun. 24, 2021

(54) SYSTEM AND METHOD FOR AUTOMATED SUPERVISION OF CONSUMPTION AND INVENTORY OF APPLIANCE CONSUMABLES

(71) Applicant: KWIK COMMERCE LTD., Tel Aviv (IL)

(72) Inventors: Shlomi ATIAS, Yokneam (IL); Evgeni MASHKEVICH, Ashdod (IL)

(73) Assignee: KWIK COMMERCE LTD., Tel Aviv (IL)

(21) Appl. No.: 17/057,345

(22) PCT Filed: May 23, 2018
(86) PCT No.: PCT/IL2018/050561

§ 371 Date: Nov. 20, 2020

Related U.S. Application Data
(60) Provisional application No. 62/597,948, filed on Dec. 13, 2017.
(60) Provisional application No. 62/584,828, filed on Nov. 12, 2017.
(60) Provisional application No. 62/522,103, filed on Jun. 20, 2017.
(60) Provisional application No. 62/509,762, filed on May 23, 2017.

(51) Int. Cl. A47L 15/44; A47K 10/32; G06Q 10/06

(52) U.S. Cl. CPC A47L 15/449; A47K 2010/3226; G06Q 10/06; A47K 10/32

(57) ABSTRACT

The present invention provides a system and method for supervising consumption and inventory of appliance consumables. The system comprises an appliance monitor that is placed on or next to an appliance. The appliance module includes one or more sensors measuring physical properties affected by operational modes of the appliance. The appliance module includes a processor that determines in which operational mode the appliance is operating. A server identifies a utilization cycle of the appliance as a function of an aggregation of one or more operational modes. The server further determines an amount of consumption of the consumable connected with the utilization cycle. The server tracks an inventory of the consumable for the appliance. The server can respond accordingly by sending a message for, inter alia, placing an order for delivery of a new supply of the consumable or for a repair service visit to the site of the appliance.

The present application claims the priority of the following US provisional patent applications, incorporated herein by reference:
62/509,762, filed 23 May 2017;
62/522,103, filed 20 Jun. 2017:
62/584,828, filed 12 Nov. 2017; and
62/597,948, filed 13 Dec. 2017.

### FIELD OF THE INVENTION

The invention is in the field of consumption and inventory supervision.

### BACKGROUND TO THE INVENTION

There have been a number of disclosures for methods and sensors that monitor appliances and supervise consumption of consumables:

US2004/112917A discloses a drink dispensing cart apparatus. The apparatus comprises a pressure sensor in an outlet line, extending between the pump and drink dispensing machine, which senses when water is needed by the dispenser; and a pressure sensor in an inlet line, extending between the pump and the container of water, which senses when the container of water is empty and needs replacing.

KR2011/0003737A discloses a plate for supporting a water bottle to accurately sense an amount of water in the water bottle and to display the water amount in stages.

WO2009/023007A1 discloses a supply system for providing water from a bottled water cooler. The system includes a control device comprising a microcontroller that monitors upper and lower sensors. The microcontroller controls the operation of a pump so that the water level goes no lower than the lower sensor and no higher than the higher sensor.

US2015/294553A discloses an apparatus that detects sounds of potential interest from appliances and sends a notification to a user. The signals produced are compared with a database of signals, producing a notification to a user when a match is found.

US2014085100A discloses a remote notification electronic rodent trapping system and method is provided having a plurality of electronic rodent trapping devices configured to wirelessly communicate trap information to each other and to a PC or wireless device.

RU2539340C2 discloses a dispenser with a level gage to determine of the level of consumable paper article in dispenser. A sensor unit incorporates two sensor elements, each detecting the light reflected from reflecting field located at paper article, or reveals the absence of paper. Data from sensors are transmitted via wireless line to server for further processing, for example, for notification of cleaner who services the lavatory.

U.S. Pat. No. 5,878,381 discloses a system for collecting data on individual and aggregate use of toilet tissue or other types of rolled absorbent paper in a public washroom. The system includes a sensing system for sensing one or more characteristics of paper use at a particular dispensing location, and a recording system for receiving and recording data from said sensing system, whereby paper use at the dispensing location can be monitored and studied. The system further analyzes the data to determine such things as the total amount of paper used, the duration of time over which paper is used, the number of discrete pulls on the paper taken by a user and the amount of paper taken by a user per discrete pull.

US2014/0367401A1 discloses a dispenser for dispensing paper or non-woven sheet product for wiping, the dispenser comprising an ultrasonic level sensor for determining the level of the sheet product contained in the dispenser, wherein the ultrasonic sensor is arranged to direct the ultrasonic beam toward a surface associated with the sheet product, wherein a distance that the beam travels to the surface changes progressively as the level of the sheet product in the dispenser changes from a full condition to an empty condition.

GB2489965A discloses a system for indicating paper dispensing status of a paper dispenser located in a toilet compartment. The system includes a sensor unit comprising a sensor, which detects at least one characteristic relating to toilet paper consumption in the paper dispenser; a processing unit, which receives data from the sensor unit and estimates current dispensing status of the paper dispenser, where the data includes the paper consumption characteristic; and a presentation unit, which indicates the current dispensing status. The presentation unit is located in vicinity of the toilet compartment in a manner which allows a user to view the dispensing status indication prior to entering the respective toilet compartment. Also disclosed is an apparatus and method for indicating paper dispensing status.

### SUMMARY

An aspect of the invention is directed to a system and method for automated supervision of consumption and inventory of appliance consumables. The system features a novel appliance module that is placed on or next to an appliance that expends a consumable and/or wears out in the course of a utilization cycle. The appliance module includes one or more sensors that measure physical properties affected by one or more operational modes of the appliance, such as temperature and/or vibration. The appliance module includes a processor and memory configured to determine in which operational mode an appliance is operating.

A server receives and aggregates data of operational modes of the appliance and identifies, as a function of a run of one or more operational modes, a utilization cycle of the appliance. The server further determines an amount of consumption of the consumable or wear of the appliance connected with the utilization cycle. The server tracks an inventory (typically located at a site of the appliance) of the consumable or total wear of parts of the appliance, and can respond accordingly by automatically placing an order for delivery of a new supply of the consumable or a call by a service representative to the appropriate site.

The appliance monitor and the server can be configured to support one or more of a large variety of appliances, such as different manufacturers and models of refrigerators, washing machines, dishwashers, coffee machines, and water coolers. The system can also monitor non-electrical devices, such as mousetraps and paper-towel dispensers.

It is therefore an object of the invention to provide a system for supervising consumption and inventory of a consumable expended through utilization of an appliance; the system comprising an appliance monitor (105) and a server (190), with the appliance monitor (105) comprising
a. one or more sensors configured for obtaining measurements of one or more physical properties; the one or more sensors are disposed on or next to the appliance and
b. a microcontroller configured to receive the measurements and determine one or more operational modes of the appliance as a function of the measurements; and
c. a reporting module, configured to send a report of the one or more operational modes to the server;
the appliance monitor is non-integral and electrically unconnected with the appliance; and the server (190) comprising:
d. a communication module configured to receive the operational mode reports of the one or more sensors (120) from the reporting module; and
e. an inventory module configured to
   i. track an inventory amount of the consumable associated with the appliance;
   ii. update the inventory amount by deducting a consumption amount—corresponding to the one or more operational modes—from the updated inventory amount; and
   iii. determine a need for a service message, according to a the updated the inventory amount; and
f. a service module configured to issue the determined service message to a recipient, in cooperation with the communication module;
wherein the microcontroller is normally in a sleep mode; at least one of the one or more sensors is a triggering sensor; and the microcontroller wakes up from the sleep mode upon receiving a threshold output from the triggering sensor.

It is a further object of the invention to provide the abovementioned system, the server (190) further comprising
a. an aggregation module configured to receive the operational mode reports and store one or more of the operational modes into an operational mode aggregation;
b. a utilization cycle database storing a utilization cycle specification for one or more utilization cycles of the appliance; the utilization cycle specification comprising an expected consumption amount for each the utilization cycle; and
c. a correlation module, configured to match the operational mode aggregation with a the utilization cycle in the utilization cycle specification;
wherein the consumption amount is specified in the utilization cycle specification for the utilization cycle matched to the operational mode aggregation.

It is a further object of the invention to provide the abovementioned system, the server further comprising a personalization database (250) configured to provide a personalization specification (255) for the appliance (110), specifying one or more of a personalized consumption amount, a personalized rate of consumption, a personalized surplus, wherein the inventory module (230) is further configured to employ a the personalization specification (255) in order to update the inventory amount.

It is a further object of the invention to provide the abovementioned system, wherein the one or more sensors is selected from a group comprising an accelerometer, barometer, acoustic sensor, thermometer, gyroscope, photodetector, camera, magnetometer, water conductivity sensor, water hardness sensor, salts detector, TDS sensor, turbidity sensor and any combination thereof.

It is a further object of the invention to provide the abovementioned system, wherein the server employs a multi-sensor fusion function of a plurality the sensors to determine the operational modes.

It is a further object of the invention to provide the abovementioned system, wherein the server is selected from a group comprising a cloud server, a dedicated server, and any combination thereof.

It is a further object of the invention to provide the abovementioned system, wherein the service message is an alert to a user device 240 about a status of the inventory amount.

It is a further object of the invention to provide the abovementioned system, wherein the service message is an electronic purchase order for the consumable, deliverable to a location associated with the appliance 110.

It is a further object of the invention to provide the abovementioned system, wherein the inventory module is further configured to make an inventory prediction as a function of the personalization specification.

It is a further object of the invention to provide the abovementioned system, wherein the inventory module is further configured to estimate when the inventory status will reach zero inventory of the consumable.

It is a further object of the invention to provide the abovementioned system, wherein the inventory module and the service module are further configured to arrange that the ordered consumable is delivered before the estimated time when inventory reaches zero.

It is a further object of the invention to provide the abovementioned system, wherein the server is further configured to determine a servicing requirement of the appliance.

It is a further object of the invention to provide the abovementioned system, wherein the appliance monitor further comprising a power source selected from a group consisting of a disposable battery, a rechargeable battery, a built-in battery, and any combination thereof.

It is a further object of the invention to provide the abovementioned system, wherein the appliance is a coffee machine.

It is a further object of the invention to provide the abovementioned coffee machine supervision system, wherein the one or more sensors are selected from a group consisting of an acoustic vibration sensor and an accelerometer.

It is a further object of the invention to provide the abovementioned coffee machine supervision system, wherein the physical properties are selected from a group consisting of a frequency, volume, amplitude, duration, and any combination thereof; and the operational modes are selected from a group consisting of filling a cup with a quantity of coffee, grinding of coffee beans, expending a coffee cartridge, dispensation of a coffee additive, and any combination thereof.

It is a further object of the invention to provide the abovementioned coffee machine supervision system, wherein the consumable is selected from a group comprising an inventory of ground coffee, coffee beans, coffee cartridges, a coffee additive, and any combination thereof.

It is a further object of the invention to provide the abovementioned coffee machine supervision system, further comprising a temperature sensor, wherein the inventory module is further configured to calculate a remaining service life of a heating element of the coffee machine, as a function of aggregated temperature measurements of the heating element by the temperature sensor.

It is a further object of the invention to provide the abovementioned coffee machine supervision system, further comprising a photodetector or turbidity sensor, wherein the message is in regard to coffee strength.

It is a further object of the invention to provide the abovementioned system, wherein the appliance is a mousetrap.

It is a further object of the invention to provide the abovementioned mousetrap supervision system, wherein the one or more sensors are selected from a group consisting of an acoustic vibration sensor, an accelerometer, and any combination thereof.

It is a further object of the invention to provide the abovementioned mousetrap supervision system, wherein the operational modes comprise: the mousetrap is open, a mouse is trapped in the mousetrap, and the mousetrap is closed with no mouse trapped therein.

It is a further object of the invention to provide the abovementioned mousetrap supervision system, wherein a set of one or more of the mousetraps with the appliance monitor is arranged in one or more facilities.

It is a further object of the invention to provide the abovementioned mousetrap supervision system, wherein the server is further configured to process the operational modes in the set of mousetraps at the facilities.

It is a further object of the invention to provide the abovementioned mousetrap supervision system, wherein the message is an alert that attention needed for the mousetraps at one of the facilities.

It is a further object of the invention to provide the abovementioned mousetrap supervision system, wherein the alert is issued a fixed time after a mouse is first trapped in a the mousetrap at the facility.

It is a further object of the invention to provide the abovementioned mousetrap supervision system, wherein an alert indicates that a predetermined number of mice have been trapped at the facility.

It is a further object of the invention to provide the abovementioned system, wherein the appliance is a water-bottle cooler.

It is a further object of the invention to provide the abovementioned water-bottle cooler supervision system, wherein the one or more sensors are selected from a group consisting of an accelerometer and an acoustic sensor.

It is a further object of the invention to provide the abovementioned water-bottle cooler supervision system, wherein the operational mode has an identifying acoustic waveform; the physical property selected from a group comprising frequency, volume, duration, and any combination thereof, of the acoustic waveform.

It is a further object of the invention to provide the abovementioned water-bottle cooler supervision system, wherein the operational modes comprise are selected from a group comprising a quantity of water being dispensed from the water cooler, changing a bottle of the water cooler, operation of a cooling system of the water cooler, and any combination thereof; the inventory amount comprises a total amount of water remaining in a bottle of the water cooler, a number of unopened bottles remaining, and any combination thereof.

It is a further object of the invention to provide the abovementioned water-bottle cooler supervision system, wherein the server is further configured to calculate inventories of water bottles for a plurality of water coolers.

It is a further object of the invention to provide the abovementioned system, wherein the appliance is a paper dispenser.

It is a further object of the invention to provide the abovementioned paper dispenser supervision system, wherein the one or more sensors are selected from a group consisting of a magnetometer, accelerometer, and acoustic sensor.

It is a further object of the invention to provide the abovementioned paper dispenser supervision system, wherein the microcontroller computes an operational mode of “the dispenser was refilled with paper” when the microcontroller receives a first response of one of the sensors followed by a second response of the sensor within a minimum time lapse between the first response and the second response.

It is a further object of the invention to provide the abovementioned paper dispenser supervision system, wherein the microcontroller determines the operational mode “the dispenser was refilled with paper” when there is a minimum time lapse between the first response and the second response.

It is a further object of the invention to provide the abovementioned paper dispenser supervision system, wherein the minimum time lapse is selected according to an expected amount of time to refill the dispenser with paper.

It is a further object of the invention to provide the abovementioned paper dispenser supervision system, wherein the minimum time lapse is configured to be about 2 seconds.

It is a further object of the invention to provide the abovementioned paper dispenser supervision system, wherein the minimum time lapse is configured to be about 5 seconds.

It is a further object of the invention to provide a method for supervising consumption and inventory of a consumable expended through utilization of an appliance; the method comprising steps of
a. obtaining a system for supervising consumption and inventory of an appliance consumable;
b. obtaining measurements of one or more physical properties from one or more sensors of an appliance monitor of the system disposed on or next to the appliance;
c. determining one or more operational modes of the appliance as a function of the measurements, by a microprocessor of the appliance monitor;
d. receiving reports of the operational modes by a server of the system;
e. tracking an inventory amount of a consumable;
f. updating the inventory amount by deducting a consumption amount, corresponding to the one or more operational modes, from the inventory amount;
g. determining a need for a service message, according to the updated inventory amount; and
h. issuing the determined service message to a recipient;
wherein the microcontroller is normally in a sleep mode; at least one of the one or more sensors is a triggering sensor; and method further comprises steps receiving a threshold output from the triggering sensor by the microcontroller and of waking up from the sleep mode by the microcontroller upon the receiving the threshold output.

It is a further object of the invention to provide the abovementioned method, further comprising steps of
a. storing the operational mode reports as an operational mode aggregation;
b. storing a utilization cycle specification for one or more utilization cycles of the appliance; the utility cycle specification comprising an expected consumption amount for each of the one or more utilization cycles;
c. matching the operational mode aggregation with one of the utilization cycles; and
d. specifying a consumption amount of the consumable associated with the utilization cycle matched to the operational mode aggregation.

It is a further object of the invention to provide the abovementioned method, further comprising a step of providing a personalization specification for the appliance, specifying one or more of a group comprising a personalized consumption amount, a personalized rate of consumption, a personalized surplus, and any combination thereof; wherein the method (700) further comprises a step of employing a the personalization specification for the step of updating the inventory amount.

It is a further object of the invention to provide the abovementioned method, wherein the one or more sensors is selected from a group comprising an accelerometer, barometer, acoustic sensor, thermometer, gyroscope, photodetector, camera, magnetometer, water conductivity sensor, water hardness sensor, salts detector, TDS sensor, turbidity sensor and any combination thereof.

It is a further object of the invention to provide the abovementioned method, further comprising a step of employing a multi-sensor fusion function of a plurality the sensors for the step of determining the operational modes ( ).

It is a further object of the invention to provide the abovementioned method, wherein the server is selected from a group comprising a cloud server, a dedicated server, and any combination thereof.

It is a further object of the invention to provide the abovementioned method, wherein the service message is an alert to a user device about a status of the inventory amount.

It is a further object of the invention to provide the abovementioned method, wherein the service message is an electronic purchase order for the consumable, deliverable to a location associated with the appliance.

It is a further object of the invention to provide the abovementioned method, further comprising a step of making an inventory prediction as a function of the personalization specification.

It is a further object of the invention to provide the abovementioned method, further comprising a step of estimating when the inventory status will reach zero inventory of the consumable.

It is a further object of the invention to provide the abovementioned method, wherein the inventory module and the service module are further configured to arrange that the ordered consumable is delivered before the estimated time when inventory reaches zero.

It is a further object of the invention to provide the abovementioned method, further comprising a step of determining a servicing requirement of the appliance.

It is a further object of the invention to provide the abovementioned method, further comprising a step of providing a power source to the appliance monitor, the power source selected from a group consisting of a disposable battery, a rechargeable battery, a built-in battery, and any combination thereof.

It is a further object of the invention to provide the abovementioned method, wherein the appliance is a coffee machine.

It is a further object of the invention to provide the abovementioned coffee machine supervision method, wherein the one or more sensors are selected from a group consisting of an acoustic vibration sensor and an accelerometer.

It is a further object of the invention to provide the abovementioned coffee machine supervision method, wherein the physical properties are selected from a group consisting of a frequency, volume, amplitude, duration, and any combination thereof; and the operational modes are selected from a group consisting of filling a cup with a quantity of coffee, grinding of coffee beans, expending a coffee cartridge, dispensation of a coffee additive, and any combination thereof.

It is a further object of the invention to provide the abovementioned coffee machine supervision method, wherein the consumable is selected from a group comprising an inventory of ground coffee, coffee beans, coffee cartridges, a coffee additive, and any combination thereof.

It is a further object of the invention to provide the abovementioned coffee machine supervision method, wherein the sensors further comprise a temperature sensor and the method further comprises a step of calculating a remaining service life of a heating element of the coffee machine as a function of aggregated temperature measurements of the heating element by the temperature sensor.

It is a further object of the invention to provide the abovementioned coffee machine supervision method, wherein the sensors further comprise a photodetector or turbidity sensor, wherein the message is in regard to coffee strength.

It is a further object of the invention to provide the abovementioned method, wherein the appliance is a mousetrap.

It is a further object of the invention to provide the abovementioned mousetrap supervision method, wherein the one or more sensors are selected from a group consisting of an acoustic vibration sensor, an accelerometer, and any combination thereof.

It is a further object of the invention to provide the abovementioned mousetrap supervision method, wherein the operational modes comprise: the mousetrap is open, a mouse is trapped in the mousetrap, and the mousetrap is closed with no mouse trapped therein.

It is a further object of the invention to provide the abovementioned mousetrap supervision method, further comprising a step of arranging one or more of the mousetraps with the appliance monitor in one or more facilities.

It is a further object of the invention to provide the abovementioned mousetrap supervision method, further comprising a step of identifying the operational modes in the set of mousetraps at the facilities.

It is a further object of the invention to provide the abovementioned mousetrap supervision method, wherein the message is an alert that attention is needed for the mousetraps at a the facility.

It is a further object of the invention to provide the abovementioned mousetrap supervision method, wherein the alert is issued a fixed time after a mouse is first trapped in a the mousetrap at the facility.

It is a further object of the invention to provide the abovementioned mousetrap supervision method, wherein a the alert indicates that a predetermined number of mice have been trapped at the facility.

It is a further object of the invention to provide the abovementioned method, wherein the appliance is a water-bottle cooler.

It is a further object of the invention to provide the abovementioned water-bottle cooler supervision method, wherein the one or more sensors are selected from a group consisting of an accelerometer and an acoustic sensor.

It is a further object of the invention to provide the abovementioned water-bottle cooler supervision method, wherein the operational mode has an identifying acoustic waveform; the physical property selected from a group comprising frequency, volume, duration, and any combination thereof, of the acoustic waveform.

It is a further object of the invention to provide the abovementioned water-bottle cooler supervision method, wherein the operational modes are selected from a group comprising a quantity of water being dispensed from the water cooler, changing a bottle of the water cooler, operation of a cooling system of the water cooler, and any combination thereof; the inventory amount comprises a total amount of water remaining in a bottle of the water cooler, a number of unopened bottles remaining, and any combination thereof.

It is a further object of the invention to provide the abovementioned water-bottle cooler supervision method, further comprising a step of calculating inventories of water bottles for a plurality of water coolers.

It is a further object of the invention to provide the abovementioned method, wherein the appliance is a paper dispenser.

It is a further object of the invention to provide the abovementioned paper dispenser supervision method, wherein the one or more sensors are selected from a group consisting of a magnetometer, accelerometer, and acoustic sensor.

It is a further object of the invention to provide the abovementioned paper dispenser supervision method, further comprising a step of determining an operational mode of “the dispenser was refilled with paper” when receiving a first response of one of the sensors followed by a second response of the sensor.

It is a further object of the invention to provide the abovementioned paper dispenser supervision method, further comprising a step of determining the operational mode of “the dispenser was refilled with paper” when receiving a first response of one of the sensors followed by a second response of the sensor within a minimum time lapse between the first response and the second response.

It is a further object of the invention to provide the abovementioned paper dispenser supervision method, further comprising a step of selecting the minimum time lapse according to an expected amount of time to refill the dispenser with paper.

It is a further object of the invention to provide the abovementioned paper dispenser supervision method, further comprising a step of configuring the minimum time lapse to be about 2 seconds.

It is a further object of the invention to provide the abovementioned paper dispenser supervision method, further comprising a step of configuring the minimum time lapse to be about 5 seconds.

### BRIEF DESCRIPTION OF THE DRAWINGS

FIG. 1 shows an operational block diagram of a system for automated supervision of consumption and inventory of appliance consumables, according to some embodiments of the invention.

FIGS. 2A-2D shows non-limiting examples of the system, according to some embodiments of the invention.

FIG. 3 shows a flow diagram of a method for automated supervision of consumption and inventory of appliance consumables, according to some embodiments of the invention.

### DETAILED DESCRIPTION

Non-limiting embodiments of the invention are now described in detail.

In this application, a “utilization cycle” refers to a utilization of an appliance that can be matched with an expected amount of a consumable dispensed during the utilization. Matching may take into account behavior patterns of dispensation of the consumable by a typical or specific user of the appliance.

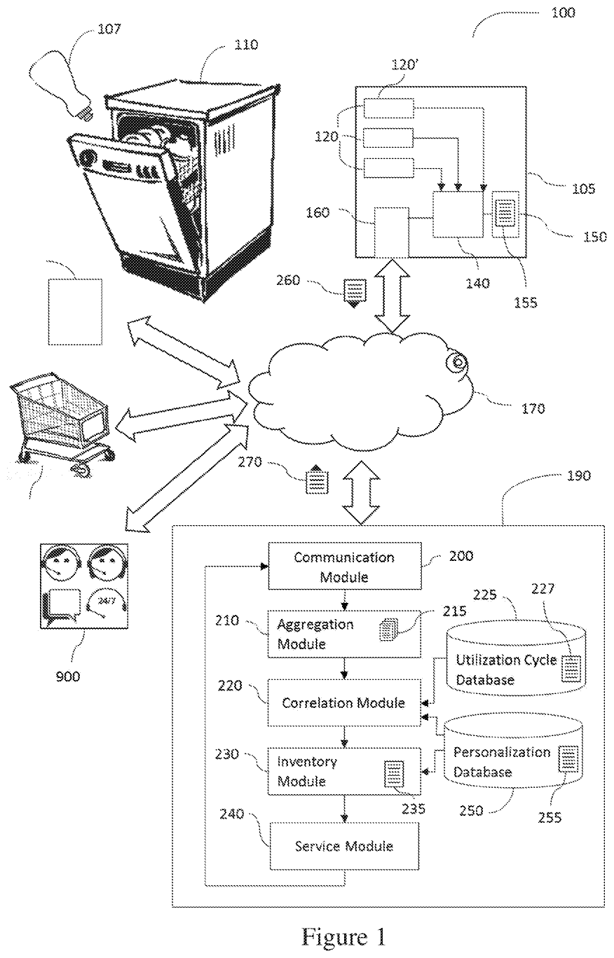

Reference is now made to FIG. 1. In an exemplary embodiment of the invention, a consumables supervision system 100 comprises an appliance monitor 105 and a server 190.

Appliance monitor 105 comprises one or more sensors 120, at least one of which is a triggering sensor 120′; a power source 125; a processor 130; and a reporting module 160. In a preferred embodiment, all components of appliance monitor 105 are disposed in a single unit (box), as shown. Alternatively, one or more components of appliance monitor 105 may be disposed in physically separated locations.

Appliance monitor 105 is disposed in proximity with an appliance 110, either on or next to appliance 110. Appliance monitor 105 is non-integral and electrically unconnected with appliance 110. Placement of appliance monitor 105 requires special skills, and may be performed, for example, by a consumer user of appliance 110. Appliance monitor 105 may be adhered to appliance 110; for example, magnetically, by gluing, with a hook-and-loop fastener (i.e., Velcro), or simply placed on or alongside appliance 110.

Sensors 120 may all be disposed together in a single unit. Alternatively, any of sensors 120 may be separately disposed; for example, where optimal positions of each of sensors 120 are in different places in relation to appliance 110.

Sensors 120 each measure one or more physical quantities. The measured physical quantities are affected by one or more operational modes of appliance 110. For example, two sensors of a dishwasher monitor are placed near a dishwasher. One sensor 120, an accelerometer, measures vibrations, which are affected by spraying of water and rotation of the dishwasher's spraying arms. Another sensor 120 measures temperature, which is affected by water temperature.

Operational modes are associated, individually or in their aggregate, with consumption of a consumable 107 used with appliance 110. A method of determining consumption of consumable 107 as a function of operational mode(s) of appliance 110 is further described herein.

Microcontroller 140 can be an equivalent IC, such as an FPGA, for receiving data and performing computational functions. Microcontroller 140 may be accompanied with a non-transitory computer readable medium (CRM) 150, such as RAM and/or flash memory. Microcontroller 140 is programmed with instructions. The programming instructions may be stored in CRM 150 or in microcontroller 140 itself. The programming instructions are configured for microcontroller 140 to receive measurement signals from sensors 120. Preferably, digitization of signals from a sensor is performed internally by microcontroller 140; alternatively an external A/D converter may be used. The instructions are further determine an operational mode of appliance 110 as a function of the received sensor

Microcontroller 140 is a power-saving microcontroller with at least two modes of operation: an awake (active) mode and a lower-power sleep mode. In the sleep mode, microcontroller 140 consumes relatively little power. Such power-saving microcontrollers are well known in the art.

In system 100, microcontroller 140 is normally in the sleep mode. Optionally, non-transitory computer readable medium 150 and/or some of sensors 120 are also normally in a sleep 55 mode. One of sensors 120 is a triggering sensor 120′ that is normally awake and continuously monitors a triggering physical quantity.

A predefined output of triggering sensor 120′—for example, a measurement exceeding a certain predefined threshold—wakes up microcontroller 140 from the sleep mode. While in awake mode, microcontroller 140 begins digitally recording measurements from some or all of the sensors 120. From the recordings of sensor outputs, microcontroller 140 determines an operational mode of appliance 110.

Continuing with the example of the dishwasher monitor, the accelerometer is a trigger sensor 120′. The accelerometer measures vibrations caused by a spraying cycle of the dishwasher and converts the vibrations into a signal. The signal exceeds a threshold and therefore wakes up microcontroller 140 from the sleep mode. While in awake mode, the microcontroller 140 records measurements from the microphone and the temperature sensor, thereby determining a spray cycle of the dishwasher. Alternatively, to further reduce power consumption, the accelerometer signal exceeding the threshold can cause microcontroller 140 wake up periodically for a short time (e.g., 50 ms every second) to monitor the signals from the accelerometer and temperature sensor, and then return to sleep mode. Upon conclusion of the vibrations induced by the spraying cycle, the accelerometer signal goes below the threshold and microcontroller 140 returns to its normal sleep mode.

In an alternative embodiment, while the accelerometer signal is below the threshold microcontroller 140 can be in the sleep mode and wake up periodically for a short time (e.g., 50 ms every second) to sample the sensors, and then in the awake mode when the accelerometer signal is exceeds the threshold.

Appliance monitor 105 may be pre-configured with information for converting signals from sensors 120 into operational modes of appliance 110. CRM 150 can store an operational mode profile 155 of appliance 110, such as data (e.g., a sequence) of operational modes of appliance 110 and/or expected signals from sensors 120 for onset and continuing operation at operational modes of appliance 110. Microcontroller 140 can be configured (by design or by programming) to dynamically adjust the threshold of triggering sensor 120′, according to an expected operational mode of appliance 110. Microcontroller 140 can be configured to employ measurement signals from sensors 120 in order to verify or determine a present operational mode. Microcontroller 140 can be configured to employ feature extraction techniques to determine a present operational mode from a waveform of a sensor output signal. Microcontroller 140 can be configured to employ a multi-sensor fusion function of a plurality of signals from sensors 120 in order to determine a present operational mode.

In some embodiments, microcontroller 140 configuration (e.g., its firmware, or instructions or operational mode profile 155 in CRM 150) is updated automatically from server 190. Updated configurations can include an improved operational mode profile 155, obtained through ongoing training data from a plurality of appliance monitors 105 each monitoring the same model of appliance 110. Additionally, from individualized training data of single instances of appliance 110, to compensate for idiosyncratic behavior of appliance 110.

After determining an operational mode, microcontroller 140 encapsulates operational mode data, which can include a time stamp. Microcontroller may store operational mode data in CRM 150 and/or send operational mode data to reporting module 200.

Reporting module 160 receives operational modes data and sends operational mode reports 260 to one or more computing devices external to appliance monitor 105. Reporting module 160 may send reports 260 of operational modes one-by-one for each an operational mode determined by microcontroller 140, or may send reports 260 in groups of operational modes. Operational mode reports 260 may include identifying metadata such as an ID of appliance 110 and/or user thereof, manufacturer and model of appliance 110, an address of appliance 110, etc.

Reporting module 160 may employ any suitable cellular, wireless, or cabled network protocols to facilitate communication with the computing device. Communication may be physically direct (e.g. using Bluetooth or WiFi), transmitted through a LAN, or routed through a WAN (e.g., using a VPN over the Internet).

In an exemplary embodiment of the invention, a consumables supervision system 100 comprises an appliance monitor 105 and a server 190. Additional processing of operational mode reports 260 is made by server 190. However, it is understood that some or all of this processing may be performed by microcontroller 140 of appliance module 105. Alternatively, or in addition, some computational functions of appliance monitor 105 described herein may be performed by server 190; for example, so as to reduce computations and power consumption by appliance monitor 105.

Server 190 is preferably a cloud server 190 accessed through a cloud infrastructure 170, as shown, but can also be a dedicated server or any combination of cloud and dedicated server(s).

For purposes of clarity, the function of server 190 is described through a utilization of one appliance 110. However, it is understood that server 190, or a plurality thereof, may be configured to serve multiple instances of the same model of appliance 110. Additionally, server 190 may service a number of different models and types of appliances (e.g., server 190 may receive operational mode reports from appliance monitors 105 monitoring washing machines, dishwashers, coffee makers, etc.).

Server 190 comprises a communication module 200. Communication module 200 is in communicative connection with a reporting module 160 of appliance monitor 105. Communication module 200 receives operational mode reports 260 from reporting module 160 of appliance monitor 105. Communication between reporting module 160 and communication module 200 can be through any combination of hardware and software protocols known in the art. In some embodiments, the communication is made through Internet of Things (IoT) protocols.

In some embodiments, server 190 comprises an aggregation module 210. Aggregation module 210 receives operational mode reports 260. Aggregation module assembles and stores the operational modes into an operational mode aggregation 215.

In some embodiments, server 190 comprises a utilization cycle database 225. Utilization cycle database 225 stores one or more specifications 227 of one or more utilization cycles of appliance 110. Utilization cycle specification 227 may specify a sequence of operating modes of appliance 110, and their durations, for various kinds of utilization. Utilization cycle specification 227 may specify an operating mode duration as a function of service level of a utilization. For example, for a dishwasher that adjusts the wash duration depending on the quantity of dirty dishes. Utilization cycle specification 227 may specify an amount of consumable 107 expected to be used in the utilization cycle. For example, how much dishwashing detergent powder is recommended or expected by a typical user to dispense of dishwashing soap for a particular quantity of dishes.

Utilization cycle specification 227 may be supplied by a manufacturer of appliance. Alternatively, or in addition, utilization cycle specification 227 may be constructed or improved by training data taken during testing of different utilization types on a number of different appliances 110 of the same model.

In some embodiments, server 190 further comprises a personalization database 250. Personalization database 250 stores one or more personalization specifications 255, which are specific to each instance of an appliance 110 and its users. Personalization specification 255 may comprise data of patterns of consumption of consumable 107 by one or more users of appliance 110. Personalization specification 255 can specify average or expected consumption amounts of consumable 107 used for particular utilization cycles of appliance 110. Personalization specification 255 may store patterns of consumption and ordering of consumables for appliance 110. Personalized information may be improved by testing a number of utilizations by a user of appliance 110 monitored by appliance monitor 105, where the user specifies how much of disposable 107 was used; either for each use or over a period of time as determined, for example, by frequency of placing orders for consumable 107.

In some embodiments, server 190 further comprises a correlation module 220. Correlation module 220 receives operational mode aggregations 215. Correlation module 220 seeks patterns for matching an operational modes aggregation 215 with a utilization cycle specification 227 in utilization cycle database 225. Correlation module determines the expected consumption amount of consumable 107 during the utilization cycle, either taken directly from utilization cycle specification 227 or, if available, from personalization specification 255.

Correlation module 210 may conclude that a particular utilization cycle and consumption has occurred on the basis of matching one or more operational modes in aggregation 215 with operational modes specified in a utilization cycle specification 227.

If a match is not found, correlation module 220 may employ statistical models to determine a utilization cycle and consumption of consumable 107.

Correlation module 210 may conclude that no utilization or consumption was made, if a set of one or more operational modes is not corroborated by other operational modes expected to occur during a utilization cycle.

Server 190 further comprises an inventory module 230. Inventory module 230 maintains and updates an inventory 235 of consumable 107 for said appliance 110. Where a known consumption amount is dispensed in a single operational mode (e.g., in an example described further herein, a setting of a spring of a mousetrap is “consumed” in a single snap of the spring), operational mode reports 260 received by inventory module 230 from communication module 200 are sufficient for updating of inventory 235. Where a utilization cycle must first be determined from operational modes before determining a consumption amount, then correlation module 220 determines consumption amount as a function of one or more aggregations 215 and a utilization cycle specification 227, and, optionally, a personalization specification 255.

After receiving a consumption amount, inventory module 230 adjusts an inventory amount 235 of consumable 107. Inventory amount 235 can include number of unopened units of consumable 107 remaining (e.g., at a facility or home where appliance 110 is located). Inventory amount 235 can include a quantity remaining in packages already opened.

Based on a present inventory amount 235, inventory module 230 may make predictions of when inventory of consumable 107 will reach zero, or a margin of surplus. Inventory module 230 may make employ personalization specification 255 of said appliance 110 to determine a rate of use and/or a desired margin of surplus of consumable.

As a result of a present inventory or a prediction, inventory module 230 determines a kind of service message 270, if any, is needed. A service message 270 can be a notification to a user device 240 that stock of consumable 107 is low or depleted. A service message 270 can be an online order for a specified quantity of consumable 107 to an online store server 800. A service message 270 can be a service request to a server 900 of an appliance service center.

Server 190 further comprises a service module 240. Service module 240 receives requests from inventory module 230 to send service messages 270. Service module 240 prepares the requested service message to the appropriate recipient. Communication module 200 receives and sends service message 270.

If necessary, service module 240 monitors service requests initiated by service message 270. For example, service module 240 may receive a message reporting that an order for consumable 170 was delivered. Service module 240 receives this message and notifies inventory module 230, in order for inventory module 230 to update inventory amount 235 accordingly. Service module 240 may receive manual orders and cancellations from user devices 240. Service module 240 tracks dispositions of the orders and cancellations and upon final disposition closes the order and informs inventory module 230 of the final disposition.

Non-limiting examples are now provided for different appliances in order to further elucidate functions and utility of the invention.

Coffee Machine

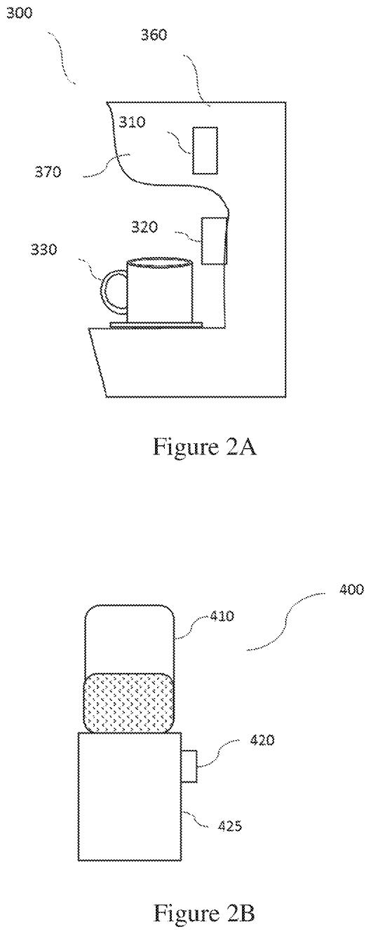

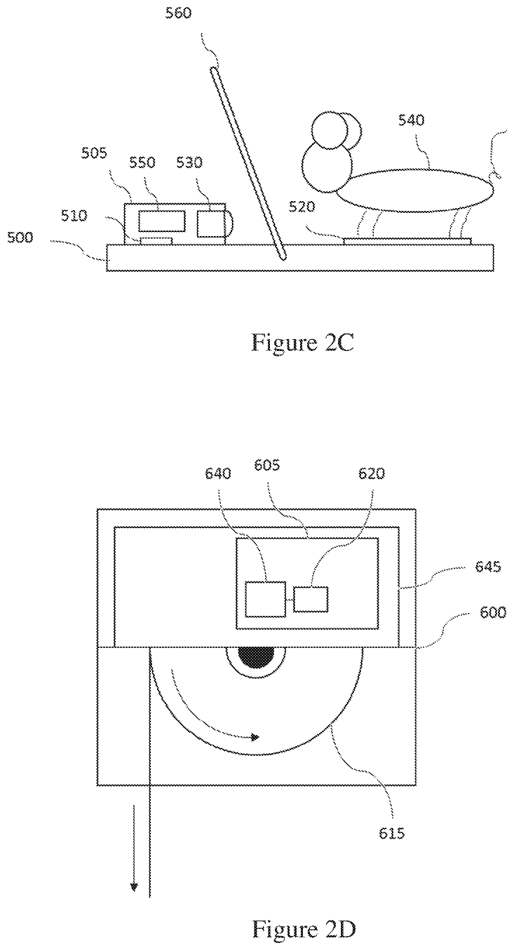

Reference is now made to FIG. 2A, showing a coffee-machine monitor 310 monitoring a coffee machine 300 as part of a consumption supervision system 100, according to some embodiments of the invention.

Coffee-machine monitor 310 comprises an accelerometer or acoustic sensor. Coffee-machine monitor 310 measures characteristics of vibrations of coffee machine 300, such as frequency, amplitude, and/or duration of vibration. Coffee-machine monitor 310 determines what operations of coffee machine are performed during the vibrations. Optionally, a microphone 320 can be placed near a receiving cup 330, in order to monitor sounds of coffee pouring into cup 330. Operations can include grinding of coffee beans and dispensing a particular quantity and type of coffee, such as espresso or cappuccino. Correlation module of server 190 can determine an amount coffee beans, ground coffee, coffee cartridges, and/or coffee additives such as milk were consumed during a series of operations in a utilization of coffee machine 300. Inventory module 230 of server 190 can maintain an inventory of the consumables and take appropriate actions to ensure that uninterrupted supplies of the consumables will be available. Correlation module 220 and inventory module 230 can take into account patterns of how users of a particular coffee machine 300 consume and stock coffee and coffee additives.

Water-Bottle Cooler

Reference is now made to FIG. 2B, showing a water-bottle cooler monitor 420 monitoring a water cooler 400 as part of a consumption supervision system 100, according to some embodiments of the invention.

Water-bottle cooler 400 comprises a water bottle 410 and base unit 425. Water-bottle cooler monitor 420 is adhered base unit 425, preferably near bottle 410. Water-bottle cooler monitor 420 measures characteristics of vibrations of water-bottle cooler 400, such as frequency, amplitude, and/or duration of vibration. Water-bottle cooler monitor 420 determines what operations of water-bottle cooler 400 are performed during the vibrations. Water-bottle cooler monitor may measure vibrations caused by pouring water, air bubbles rising in water bottle 410, vibrations of machinery in base unit 425, sound of replacement of water bottle 410, and any combination thereof. Operations can include pouring a quantity of water and replacing water bottle 410. Correlation module of server 190 can determine an amount of water poured and/or a replacement of water bottle 400. Inventory module 230 of server 190 can maintain an inventory of water remaining in water bottle 410 and/or number of water bottles 410 in an inventory of water bottles 410 and take appropriate actions to ensure an uninterrupted supply of water bottles 410 will be available. Correlation module 220 and inventory module 230 can take into account patterns of how users of a particular water cooler 400 consume and stock water bottles 410.

Mousetrap

Reference is now made to FIG. 2C, showing a mousetrap monitor 505 monitoring a mousetrap 500 as part of a consumption supervision system 100, according to some embodiments of the invention.

Mousetrap monitor 505 comprises an accelerometer or acoustic sensor 510 and microcontroller 550. Optionally, mousetrap monitor further comprises a motion detector 530 (for example, a passive infrared mammalian body motion sensor). Mousetrap monitor 505 is adhered to mousetrap 500. A mousetrap 500/mousetrap monitor 505 combination may be placed in each of a plurality of locations of a home or other facility.

Sensor 510 generates a signal in response to a snapping shut of a spring-bar 560 of mousetrap 500, caused by a mouse 540 stepping on a trip 520 of mousetrap 500. Signal of accelerometer 510 above a threshold will wake up microcontroller 550 from sleep mode, whereupon processor receives measurements from accelerometer 510 and, optionally, from motion detector 530. Threshold may be set at or below a signal level received from accelerometer 510 from force of a kick reaction to beginning of spring-bar 560 motion. Optionally, microcontroller 550 is programmed to discern between sensor signals from a “soft” snap of spring-loaded bar 560 against mouse 540 (indicating successful trapping of mouse 540) and the “hard” snap of spring-bar 560 against trip 520 (indicating spring-loaded bar 560 was tripped with no mouse 540 trapped).

Mousetrap monitor 505 periodically reports to server 190 its status: a) the mousetrap is still open; b) a mouse is trapped in the mousetrap; and c) the mousetrap is closed with no trapped mouse.

A mousetrap 500/mousetrap monitor 505 combination may be placed in each of a plurality of locations of a home or other facility. Statuses of mousetraps 500 may be stored in aggregation module 210. When a pre-determined number of mousetraps 500 have been closed or mice 540 have been trapped, server 190 may send an alert to a computing device 240; for example, to notify a proprietor of the warehouse. Alternatively, or in addition, an alert is sent to a user device 240 some fixed time after a first time a mouse is trapped, in order to minimize decay odors. Alternatively, or in addition, communication module 200 of server 190 notifies an external server 900 of an extermination service that mousetraps 500 should be reset/emptied. Alternatively, or in addition, an order for more mouse bait may be placed with an online store 800.

Paper Dispenser

Reference is now made to FIG. 2D, showing a paper-dispenser monitor 605 monitoring a paper dispenser 600 as part of a consumption supervision system 100, according to some embodiments of the invention.

Paper-dispenser monitor 605 is adhered to a moveable part—in FIG. 2D, a flap 645—of paper dispenser 600 that is swung or moved in order to open paper dispenser 600 for filling paper dispenser 600 with a new supply of paper 615. A sensor 620 of paper-dispenser monitor 605, such as a magnetometer or accelerometer, is responsive to the motion. When flap 645 is opened, sensor 620 responds to motion of sensor module. Microcontroller 640 is awaken by a threshold signal of sensor 620 and receives a first response from sensor 620. When flap 645 is closed after replacing paper 615, microcontroller 640 receives a second response from sensor 620. Microcontroller 640 determines that paper 615 in paper dispenser 600 was refilled. Preferably, microcontroller 140 determines a refill only if at least a minimum time required to refill dispenser 610 elapses between the first and second responses. For example, the minimum elapsed time can be set somewhere between around two seconds and around five seconds. Optionally, the minimum time can be set by a user. In some embodiments, if a second response is not received within a maximum time after a first response, microcontroller 640 will ignore the first response. Paper dispenser monitor 605 may communicate each refill to server 190, for updating of paper inventory in inventory module. Alternatively, paper dispenser monitor 605 may record how many times paper 615 was refilled and periodically report to server 190.

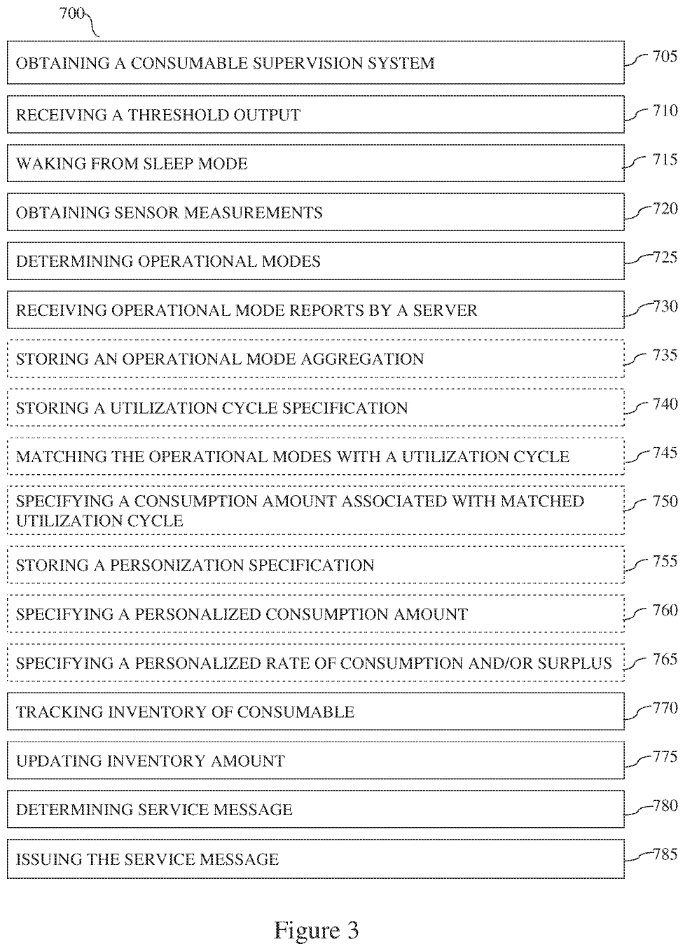

Reference is now made to FIG. 3, showing a flow diagram of a method 700 for automated supervision of consumption and inventory of appliance consumables, according to some embodiments of the invention.

Method 700 comprises a step of obtaining a system for automated supervision of consumption and inventory of appliance consumables 705.

Method 700 further comprises a step of receiving, by a microcontroller of an appliance monitor of the system, a threshold output from a triggering sensor among one or more sensors of the appliance monitor disposed on or near an appliance 710.

Method 700 further comprises a step of waking up from a sleep mode by the microcontroller upon receiving the threshold output 715.

Method 700 further comprises a step of obtaining measurements of one or more physical properties from the one or more sensors 720.

Method 700 further comprises a step of determining one or more operational modes of the appliance as a function of the measurements 725.

Method 700 further comprises a step of receiving reports of the operational modes by a server of the system 730.

In some embodiments, method 700 further comprises a step of storing the operational mode reports as an operational mode aggregation 735.

In some embodiments, method 700 further comprises a step of storing a utilization cycle specification for one or more utilization cycles of the appliance; the utility cycle specification comprising an expected consumption amount for each of the one or more utilization cycles 740.

In some embodiments, method 700 further comprises a step of matching the operational mode aggregation with one of the utilization cycles 745.

In some embodiments, method 700 further comprises a step of specifying a consumption amount of the consumable associated with the utilization cycle matched to the operational mode aggregation 750.

In some embodiments, method 700 further comprises a step of storing a personalization specification 755.

In some embodiments, method 700 further comprises a step of specifying a personalized consumption amount 760.

In some embodiments, method 700 further comprises a step of specifying a personalized rate of consumption and/or personalized surplus of the consumable 765.

Method 700 further comprises a step of tracking an inventory amount of the consumable 770.

Method 700 further comprises a step of updating the inventory amount by deducting a consumption amount, corresponding to the one or more operational modes, from the inventory amount 775.

Method 700 further comprises a step of determining a need for a service message, according to the updated inventory amount 780.

Method 700 further comprises a step of issuing the determined service message to a recipient 785.

1-78. (canceled)

79. A system for supervising consumption and inventory of a consumable expended through utilization of an appliance; said consumables supervision system comprising an appliance monitor and a server;
said appliance monitor comprising
e. one or more sensors configured for obtaining measurements of one or more physical properties; said one or more sensors are disposed on or next to said appliance and
f. a microcontroller configured to receive said measurements and determine one or more operational mode of said appliance as a function of said measurements; and
g. a reporting module, configured to send a report of said one or more operational modes to said server; and
said appliance monitor is non-integral and electrically unconnected with said appliance;
said server comprising:
h. a communication module configured to receive said operational mode reports of said one or more sensors from said reporting module; and
i. an inventory module configured to
i. track an inventory amount of said consumable;
ii. update said inventory amount by deducting a consumption amount, corresponding to said one or more operational modes, from said updated inventory amount;
iii. determine a need for a service message, according to a said updated said inventory amount; and
j. a service module configured to issue said determined service message to a recipient, in cooperation with said communication module; wherein said microcontroller is normally in a sleep mode; at least one of said one or more sensors is a triggering sensor and said microcontroller wakes up from said sleep mode upon receiving a threshold output from said triggering sensor;
k. an aggregation module configured to receive said operational mode reports and store one or more of said operational modes into an operational mode aggregation;
l. a utilization cycle database storing a utilization cycle specification for one or more utilization cycles of said appliance; said utilization cycle specification comprising an expected consumption amount for each said utilization cycle; and
m. a correlation module 220, configured to match said operational mode aggregation with a said utilization cycle in said utilization cycle specification;
wherein said consumption amount is specified in said utilization cycle specification for said utilization cycle matched to said operational mode aggregation.

80. The system of claim 79, further comprising a personalization database configured to provide a personalization specification for said appliance, specifying one or more of a personalized consumption amount, a personalized rate of consumption, a personalized surplus, wherein said inventory module is further configured to employ a said personalization specification in order to update said inventory amount.

81. The system of any of claim 79, wherein said one or more sensors is selected from a group comprising an accelerometer, barometer, acoustic sensor, thermometer, gyroscope, photodetector, camera, magnetometer, water conductivity sensor, water hardness sensor, salts detector, TDS sensor, turbidity sensor and any combination thereof.

82. The system of any of claim 79, wherein said server employs a multi-sensor fusion function of a plurality said sensors to determine said operational modes.

83. The system of any of claim 79, wherein said server is selected from a group comprising a cloud server, a dedicated server, and any combination thereof.

84. The system of any of claim 79, wherein said service message is an alert to a user device 240 about a status of said inventory amount.

85. The system of any of claim 79, wherein said service message is an electronic purchase order for said consumable, deliverable to a location associated with said appliance 110.

86. The system of claim 80, wherein said inventory module is further configured to make an inventory prediction as a function of said personalization specification.

87. The system of claim 86, wherein said inventory module is further configured to estimate when said inventory status will reach zero inventory of said consumable.

88. The system of claim 87, wherein said inventory module and said service module are further configured to arrange that said ordered consumable is delivered before said estimated time when inventory reaches zero.

89. The system of claim 79, wherein said server is further configured to determine a servicing requirement of the appliance.

90. The system of claim 79, wherein said appliance monitor further comprising a power source selected from a group consisting of a disposable battery, a rechargeable battery, a built-in battery, and any combination thereof.

91. The system of claim 79, wherein said appliance is a water-bottle cooler.

92. The system of claim 91, wherein said one or more sensors are selected from a group consisting of an accelerometer and an acoustic sensor.

93. The system of claim 92, wherein said operational mode has an identifying acoustic waveform; said physical property selected from a group comprising frequency, volume, duration, and any combination thereof, of said acoustic waveform.

94. The system of claim 93, wherein said operational modes comprise are selected from a group comprising a quantity of water being dispensed from said water cooler, changing a bottle of said water cooler, operation of a cooling system of said water cooler, and any combination thereof; said inventory amount comprises a total amount of water remaining in a bottle of said water cooler, a number of unopened bottles remaining, and any combination thereof.

95. The system of claim 94, wherein said server is further configured to calculate inventories of water bottles for a plurality of water coolers.

96. A method for supervising consumption and inventory of a consumable expended through utilization of an appliance; said method comprising steps of
a. obtaining the system of claim 79;
b. obtaining measurements of one or more physical properties from one or more sensors of an appliance monitor of the system disposed on or next to said appliance;
c. determining one or more operational modes of said appliance as a function of said measurements, by a microprocessor of said appliance monitor;
d. receiving reports of the operational modes by a server of the system;
e. tracking an inventory amount of a consumable;
f. updating said inventory amount by deducting a consumption amount, corresponding to said one or more operational modes, from said inventory amount;
g. determining a need for a service message, according to said updated inventory amount; and
h. issuing said determined service message to a recipient;
wherein said microcontroller is normally in a sleep mode; at least one of said one or more sensors is a triggering sensor; and method further comprises steps receiving a threshold output from said triggering sensor by said microcontroller and of waking up from said sleep mode by said microcontroller upon said receiving said threshold output.

97. The method of claim 96, further comprising steps of
a. storing said operational mode reports as an operational mode aggregation;
b. storing a utilization cycle specification for one or more utilization cycles of said appliance;
said utility cycle specification comprising an expected consumption amount for each of said one or more utilization cycles;
c. matching said operational mode aggregation with one of said utilization cycles; and d. specifying a consumption amount of said consumable associated with said utilization cycle matched to said operational mode aggregation.

98. The method of claim 97, further comprising a step of providing a personalization specification for the appliance, specifying one or more of a group comprising a personalized consumption amount, a personalized rate of consumption, a personalized surplus, and any combination thereof; wherein said method further comprises a step of employing a said personalization specification for said step of updating said inventory amount.
